(19) United States
(12) Patent Application Publication
(10) Pub. No.: US 2021/0368666 A1
(43) Pub. Date: Dec. 2, 2021

(54) QUICK COUPLER FOR A THREE-POINT HITCH

(71) Applicant: CNH Industrial America LLC, New Holland, PA (US)

(72) Inventors: Thomas James Paulson, Fargo, ND (US); Richard Dean Kerner, West Fargo, ND (US)

(21) Appl. No.: 17/334,238

(22) Filed: May 28, 2021

Related U.S. Application Data
(60) Provisional application No. 63/031,111, filed on May 28, 2020.

(51) Int. Cl. A01B 59/043

(52) U.S. Cl. CPC A01B 59/043

(57) ABSTRACT

A quick coupler for a three-point hitch includes a cross-beam configured to extend between a first main support and a second main support. The cross-beam is configured to support an anti-rotation hook. In addition, the cross-beam includes a top member extending along a length of the cross-beam and a bottom member extending along the length of the cross-beam. The top member and the bottom member are spaced apart to form a hollow portion between the top member and the bottom member. Furthermore, the cross-beam includes at least one cross-member extending from the bottom member to the top member within the hollow portion.

### CROSS-REFERENCE TO RELATED APPLICATION

This application claims priority from and the benefit of U.S. Provisional Application Ser. No. 63/031,111, entitled “QUICK COUPLER FOR A THREE-POINT HITCH”, filed May 28, 2020, which is hereby incorporated by reference in its entirety.

### BACKGROUND

The present disclosure relates generally to a quick coupler for a three-point hitch.

Certain work vehicles, such as tractors, include a three-point hitch configured to engage a corresponding hitch of a towed implement. Certain three-point hitches include two lower lift arms and an upper link. Each lower lift arm includes an opening configured to receive a corresponding lower hitch pin of the towed implement hitch, and the upper link includes an opening configured to receive a corresponding upper hitch pin of the towed implement hitch. Each hitch pin may be disposed within a corresponding opening to couple the towed implement to the work vehicle.

To reduce the duration associated with coupling the work vehicle to the towed implement, a quick coupler may be coupled to the three-point hitch. The quick coupler may include lower hitch pins and an upper hitch pin, and each hitch pin may be disposed within a corresponding opening in the three-point hitch to couple the quick coupler to the three-point hitch. In addition, the quick coupler includes two lower hooks and an upper/anti-rotation hook. The lower hooks are configured to engage the lower hitch pins of the towed implement hitch, and the upper/anti-rotation hook is configured to engage the upper hitch pin of the towed implement hitch. For example, once the quick coupler is coupled to the three-point hitch, each hook may be aligned with a corresponding hitch pin of the towed implement hitch. The quick coupler may then be raised by the three-point hitch such that each hook engages the corresponding hitch pin. In addition, one or more locking mechanisms may be engaged to secure one or more hitch pins with the respective hooks. Accordingly, the duration associated with coupling the work vehicle to the towed implement may be significantly reduced (e.g., as compared to engaging each hitch pin of the towed implement hitch with a corresponding opening of the three-point hitch), and the duration associated with switching between different towed implements may also be significantly reduced. Due to the significant forces applied to the quick coupler during operation of the work vehicle/towed implement, the quick coupler may be formed from a large quantity of material (e.g., steel). Accordingly, the cost of the quick coupler may be significant due to the large amount of material used for its construction.

### BRIEF DESCRIPTION

In certain embodiments, a quick coupler for a three-point hitch includes a cross-beam configured to extend between a first main support and a second main support. The cross-beam is configured to support an anti-rotation hook. In addition, the cross-beam includes a top member extending along a length of the cross-beam and a bottom member extending along the length of the cross-beam. The top member and the bottom member are spaced apart to form a hollow portion between the top member and the bottom member. Furthermore, the cross-beam includes at least one cross-member extending from the bottom member to the top member within the hollow portion.

### DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of a work vehicle coupled to an implement via a three-point hitch;

FIG. 2 is a front perspective view of an embodiment of a quick coupler coupled to the three-point hitch of FIG. 1;

FIG. 3 is a rear perspective view of the quick coupler of FIG. 2;

FIG. 4 is a rear view of a cross-beam of the quick coupler of FIG. 2;

FIG. 5 is a rear perspective view of the cross-beam of the quick coupler of FIG. 2; and

FIG. 6 is a rear view of another embodiment of a quick coupler configured to couple to the three-point hitch of FIG. 1.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

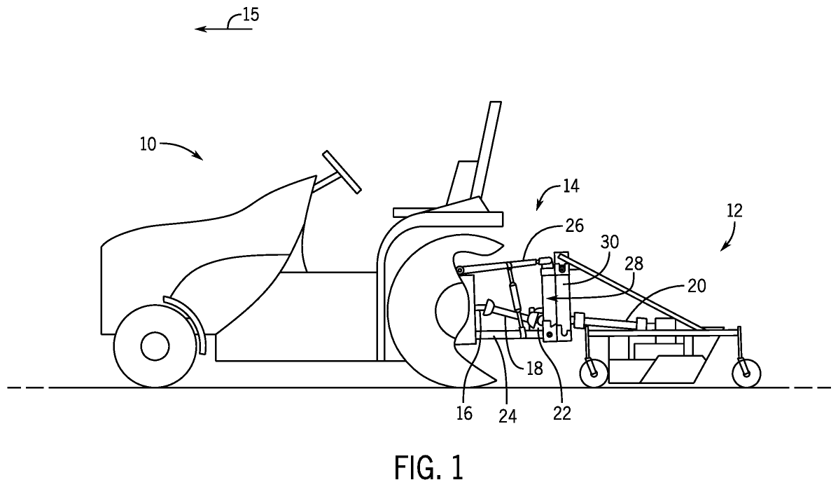

FIG. 1 is a side view of an embodiment of a work vehicle 10 coupled to an implement 12 via a three-point hitch 14. The work vehicle 10 is configured to tow the implement 12 (e.g., through a field) along a direction of travel 15. In the illustrated embodiment, the work vehicle 10 is a tractor. However, in other embodiments, the work vehicle may be any other suitable type of work vehicle configured to tow an implement, such as a harvester or a sprayer. Furthermore, in the illustrated embodiment, the implement 12 is a powered implement, such as a spreader, a rotary mower, or a rotary tiller. The implement is powered by a power-take off (PTO) shaft 16 of the work vehicle 10. An engine of the work vehicle 10 drives the PTO shaft to rotate (e.g., via a transmission, a PTO drive system, etc.), and rotation of the PTO shaft drives rotation of one or more rotary components of the implement 12, such as a rotary spreader system, mower blades, or a rotary tillage assembly. In the illustrated embodiment, the PTO shaft 16 includes a telescoping portion 18 configured to facilitate adjustment of a length of the PTO shaft 16 to accommodate different types of powered implements. However, in other embodiments, the work vehicle may have a non-telescoping PTO shaft. As illustrated, the PTO shaft 16 of the work vehicle 10 is coupled to a corresponding shaft 20 of the implement 12, and the corresponding shaft 20 of the implement 12 is configured to drive rotation of the rotary component(s) of the implement 12. The PTO shaft 16 and the corresponding shaft 20 of the implement 12 are coupled to one another via a connection assembly 22. The connection assembly 22 may include any suitable device(s) configured to couple the PTO shaft 16 to the corresponding shaft 20, such that rotation of the PTO shaft 16 drives the corresponding shaft 20 to rotate. While the implement 12 is a powered implement in the illustrated embodiment, in other embodiments, the implement may be a non-powered implement, such as a vertical tillage implement, a primary tillage implement, a seeding implement, or a finishing implement. In such embodiments, the PTO shaft of the work vehicle may not be coupled to a corresponding shaft of the implement, or the work vehicle may not include a PTO shaft.

In the illustrated embodiment, the implement 12 is coupled to the work vehicle 10 via the three-point hitch 14 of the work vehicle 10. As discussed in detail below, the three-point hitch 14 includes two lower lift arms 24 and an upper link 26. The two lower lift arms 24 and the upper link 26 are coupled (e.g., rotatably coupled) to a chassis of the work vehicle 10. In certain embodiments, an actuator is coupled to the lower lift arms and configured to drive the lower lift arms to rotate relative to the chassis of the work vehicle. Each lower lift arm 24 includes an opening configured to receive a corresponding lower hitch pin of the implement 12, and the upper link 26 includes an opening configured to receive a corresponding upper hitch pin of the implement 12. In certain embodiments, each hitch pin of the implement 12 may be disposed within a corresponding opening to couple the implement 12 to the work vehicle 10. Unfortunately, the process of coupling the hitch pins to the lower lift arms and the upper link may be time consuming, thereby increasing the duration associated with agricultural operations.

In the illustrated embodiment, a quick coupler 28 is coupled to the three-point hitch 14 to reduce the duration associated with coupling the work vehicle 10 to the implement 12. As discussed in detail below, the quick coupler 28 includes openings configured to receive two lower hitch pins and an upper hitch pin. Each hitch pin is configured to be disposed within a corresponding opening in the three-point hitch. Accordingly, the hitch pins couple the quick coupler to the three-point hitch. In addition, the quick coupler 28 includes two lower hooks and an upper/anti-rotation hook. The lower hooks are configured to engage the lower hitch pins of the implement 12 (e.g., which are coupled to a hitch frame 30 of the implement 12), and the upper/anti-rotation hook is configured to engage the upper hitch pin of the implement 12 (e.g., which is coupled to the hitch frame 30 of the implement 12). For example, once the quick coupler 28 is coupled to the three-point hitch 14, each hook may be aligned with a corresponding hitch pin of the implement 12. The quick coupler 28 may then be raised by the three-point hitch (e.g., via the actuator coupled to the lower lift arms 24), such that each hook engages the corresponding hitch pin of the implement 12. As a result, the implement 12 (e.g., the hitch frame 30 of the implement 12) is coupled to the quick coupler 28, thereby coupling the implement 12 to the three-point hitch 14 of the work vehicle 10. Accordingly, the duration associated with coupling the work vehicle 10 to the implement 12 may be significantly reduced (e.g., as compared to engaging each hitch pin of the implement with a corresponding opening of the three-point hitch), and the duration associated with switching between different implements may also be significantly reduced.

In certain embodiments, the quick coupler 28 includes a cross-beam, a first main support, and a second main support. The cross-beam extends between the first main support and the second main support, and the cross-beam is configured to support the anti-rotation hook. The cross-beam includes a top member extending along a length of the cross-beam and a bottom member extending along the length of the cross-beam. The top member and the bottom member are spaced apart to form a hollow portion between the top member and the bottom member. Furthermore, the cross-beam includes at least one cross-member extending from the bottom member to the top member within the hollow portion. For example, in certain embodiments, the at least one cross-member includes a first angled cross-member extending from the bottom member to the top member within the hollow portion and a second angled cross-member extending from the bottom member to the top member within the hollow portion. The first angled cross-member may intersect the second angled cross-member at a point along the top member. Providing the hollow portion substantially reduces the amount of material used in the construction of the quick coupler, and the cross-member(s) (e.g., the angled cross-members) provide sufficient support to enable the quick coupler to transfer the load of the implement to the three-point hitch. Due to the reduced material used in the construction of the quick coupler, the cost of the quick coupler may be significantly reduced (e.g., as compared to a quick coupler having a solid cross-beam).

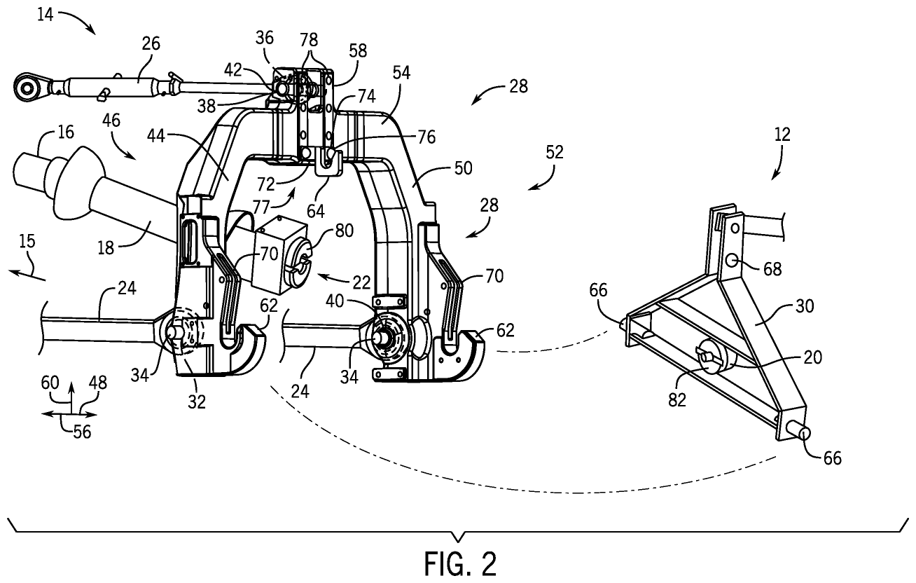

FIG. 2 is a front perspective view of an embodiment of a quick coupler 28 coupled to the three-point hitch 14 of FIG. 1. In the illustrated embodiment, each lower lift arm 24 has an opening 32 configured to receive a respective lower hitch pin 34, and the upper link 26 has an opening 36 configured to receive a respective upper hitch pin 38. In addition, the quick coupler 28 includes two lower openings 40 configured to receive the lower hitch pins 34 and an upper opening 42 configured to receive the upper hitch pin 38. The hitch pins are configured to be disposed through the openings in the three-point hitch and the quick coupler to couple the quick coupler 28 to the three-point hitch 14. In certain embodiments, each hitch pin may include an aperture on each longitudinal side of the hitch pin, and a cotter pin may be disposed through each aperture to secure the hitch pin to the three-point hitch and the quick coupler. However, in other embodiments, another suitable connection system may be used to couple the hitch pins to the three-point hitch and the quick coupler (e.g., at least one end of at least one hitch pin may include threads configured to receive a fastener, etc.).

In the illustrated embodiment, the quick coupler 28 includes a first main support 44 positioned on a first lateral side 46 of the quick coupler 28 (e.g., a first side along a lateral axis 48). In addition, the quick coupler 28 includes a second main support 50 positioned on a second lateral side 52 of the quick coupler 28 (e.g., a second side along the lateral axis 48), in which the second lateral side 52 is opposite the first lateral side 46. In addition, the quick coupler 28 includes a cross-beam 54 extending between the first main support 44 and the second main support 50 along the lateral axis 48. As illustrated, the lateral axis 48 is perpendicular to a longitudinal axis 56, which may extend along (e.g., substantially along) the direction of travel 15. In addition, each lower opening 40 is formed within a respective main support, and the upper opening 42 is formed within a support 58 extending from the cross-beam 54. As illustrated, the upper opening 42 is positioned above the lower openings 40 along a vertical axis 60.

In the illustrated embodiment, the quick coupler 28 includes two lower hooks 62 and an upper (e.g., anti-rotation) hook 64. As illustrated, a first lower hook 62 extends from the first main support 44, and a second lower hook 62 extends from the second main support 50. Each lower hook 62 is configured to engage a corresponding lower hitch pin 66 of the implement 12. As illustrated, the lower hitch pins 66 extend laterally outward from opposite lateral sides of the hitch frame 30 of the implement 12. Furthermore, the upper/anti-rotation hook 64 is configured to engage a corresponding upper hitch pin 68 of the implement 12. As illustrated, the upper hitch pin 68 is positioned at a top portion of the hitch frame 30 of the implement 12. As previously discussed, once the quick coupler 28 is coupled to the three-point hitch 14, each hook may be aligned with a corresponding hitch pin of the implement 12. The quick coupler 28 may then be raised by the three-point hitch (e.g., via the actuator coupled to the lower lift arms 24), such that each hook engages the corresponding hitch pin of the implement 12. As a result, the hitch frame 30 of the implement 12 is coupled to the quick coupler 28, thereby coupling the implement 12 to the three-point hitch 14 of the work vehicle 10. Accordingly, the duration associated with coupling the work vehicle 10 to the implement 12 may be significantly reduced (e.g., as compared to engaging each hitch pin of the implement with a corresponding opening of the three-point hitch), and the duration associated with switching between different implements may also be significantly reduced.

In the illustrated embodiment, each main support includes a respective mounting feature 70 configured to receive a respective locking mechanism. Each locking mechanism may include a moveable latch configured to selectively block removal of the respective lower hitch pin 66 of the implement 12 while the lower hitch pin 66 is engaged with the respective lower hook 62. For example, after each lower hitch pin 66 is engaged with the respective lower hook 62, the respective locking mechanism may be engaged to block removal of the lower hitch pin from the lower hook. In addition, to remove each lower hitch pin from the respective lower hook, the respective locking mechanism may be disengaged. The engagement and disengagement of each locking mechanism may be controlled by a lever or other suitable device (e.g., coupled to the first main support and/or the second main support).

Furthermore, in the illustrated embodiment, the upper/anti-rotation hook 64 is moveable between multiple positions along the vertical axis 60 (e.g., to accommodate different hitch frame configurations). In the illustrated embodiment, a mount 72 is coupled to (e.g., integrally formed with) the upper/anti-rotation hook 64, and the mount 72 includes apertures 74 configured to receive respective fasteners 76 (e.g., bolts, pins, etc.). While the mount 72 has two apertures in the illustrated embodiment, in other embodiments, the mount may include more or fewer apertures (e.g., 1, 2, 3, 4, or more) configured to receive a corresponding number of fasteners. In addition, the cross-beam 54 and the support 58 of the quick coupler 28 include a mounting feature 77 having corresponding apertures 78 configured to receive the fasteners 76. Accordingly, the fasteners 76 may be disposed through the apertures 74 of the mount 72 and the apertures 78 of the cross-beam 54/support 58 to couple the upper/anti-rotation hook 64 to the cross-beam on the implement side of the quick coupler. In the illustrated embodiment, the cross-beam and the support include four sets of apertures 78 arranged long the vertical axis 60. Accordingly, the mount 72 may coupled to the cross-beam/support at any one of four positions along the vertical axis 60, thereby positioning the upper/anti-rotation hook at a suitable vertical position for the implement. While the cross-beam/support have four sets of apertures in the illustrated embodiment, in other embodiments, the cross-beam/support may have more or fewer sets of apertures. In addition, in certain embodiments, the quick coupler (e.g., the cross-beam of the quick coupler) may have another suitable mounting feature configured to couple the upper/anti-rotation hook to the cross-beam and, in certain embodiments, to facilitate adjustment of the vertical position of the upper/anti-rotation hook (e.g., the mounting feature may include a slider mechanism, etc.). Furthermore, in certain embodiments, the upper/anti-rotation hook may be non-movably coupled to the cross-beam.

As previously discussed, the PTO shaft 16 is coupled to the corresponding shaft 20 of the implement 12 via the connection assembly 22. The connection assembly 22 includes a first connector 80 coupled to the PTO shaft 16 and a second connector 82 coupled to the corresponding shaft 20 of the implement 12. In the illustrated embodiment, the first connector 80 includes a recess configured to receive a protrusion of the second connector 82, thereby rotatably coupling the shafts to one another. However, in other embodiments, the first connector may include a protrusion and the second connector may include a recess configured to receive the protrusion to rotatably couple the shafts to one another. Furthermore, in other embodiments, the connection assembly may include any other suitable device(s)/element(s) configured to selectively couple the PTO shaft to the corresponding element implement. As previously discussed, coupling the PTO shaft to the corresponding implement shaft enables the PTO shaft to drive rotation of one or more rotatably components of the implement.

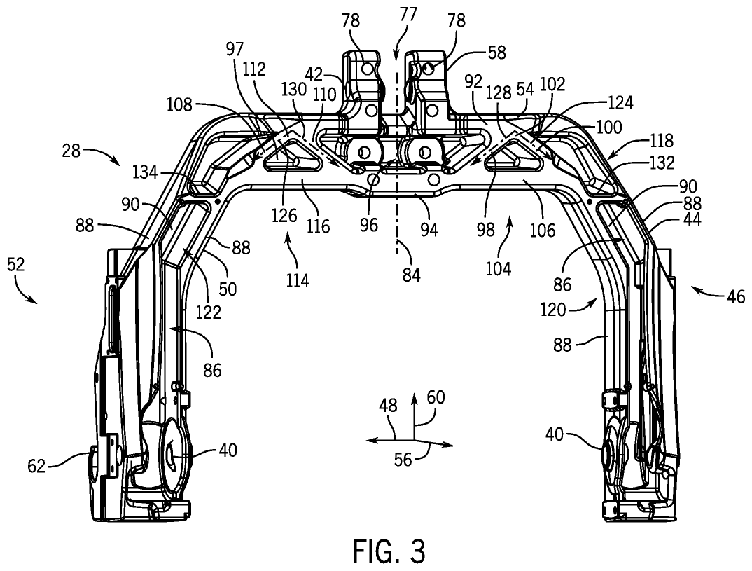

FIG. 3 is a rear perspective view of the quick coupler 28 of FIG. 2. As previously discussed, the quick coupler 28 includes the first main support 44 positioned on the first lateral side 46 of the quick coupler 28. In addition, the quick coupler 28 includes the second main support 50 positioned on the second lateral side 52 of the quick coupler 28. As illustrated, the cross-beam 54 extends between the first main support 44 and the second main support 50 along the lateral axis 48. Furthermore, the cross-beam 54 includes the mounting feature 77 configured to secure the upper/anti-rotation hook to the quick coupler 28. In the illustrated embodiment, the mounting feature 77 is positioned at a center 84 (e.g., lateral center) of the cross-beam 54/quick coupler 28 along the lateral axis 48. However, in other embodiments, the mounting feature may be laterally offset from the center, and/or the mounting feature (e.g., the apertures of the mounting feature) may be formed entirely within the support.

In certain embodiments, the quick coupler 28 (e.g., excluding the upper/anti-rotation hook) may be formed via a casting process. For example, molten metal (e.g., steel, iron, etc.) may be poured into a mold cavity having the shape of the quick coupler. After the metal cools and hardens, the quick coupler may be removed from the mold cavity and the opening/apertures may be formed (e.g., drilled, etc.) in the quick coupler. Accordingly, the quick coupler (e.g., excluding the upper/anti-rotation hook) may be formed as a single cast element (e.g., including the cross-beam formed as a single cast element, the first main support formed as a single cast element, and the second main support formed as a single cast element), thereby reducing the manufacturing cost of the quick coupler (e.g., as compared to a quick coupler formed entirely by a machining process). In certain embodiments, the quick coupler 28 may be formed from ductile iron via the casting process disclosed above. For example, the quick coupler may be formed from grade C or grade D ductile iron.

In certain embodiments, the cross-beam, the first main support, the second main support, or a combination thereof, may be formed via a casting process, and the cross-beam may be coupled to the main supports to form the quick coupler. In such embodiments, the cross-beam may be a single cast element, the first main support may be a single cast element, the second main support may be a single cast element, or a combination thereof. Furthermore, in certain embodiments, at least one of the cross-beam, the first main support, or the second main support may be formed by another suitable process, such as coupling elements (e.g., cast elements, stamped elements, etc.) to one another (e.g., via welded connection(s), via adhesive connection(s), via fastener(s), etc.) to form the completed structure. In addition, in certain embodiments, at least one of the cross-beam, the first main support, or the second main support may be formed by an additive manufacturing process (e.g., three-dimensional printing, etc.) and/or a reductive manufacturing process (e.g., machining, etc.). For example, in certain embodiments, the quick coupler (e.g., excluding the upper/anti-rotation hook) may be formed from a single piece of material via an additive manufacturing process and/or a reductive manufacturing process.

In the illustrated embodiment, the first main support 44 has a hollow portion 86 formed between lateral side members 88. The first main support 44 also includes a connecting member 90 extending between the lateral side members 88 and positioned on the implement side of the quick coupler. In addition, the second main support 50 has a hollow portion 86 formed between lateral side members 88. The second main support 50 also includes a connecting member 90 extending between the lateral side members 88 and positioned on the implement side of the quick coupler. The hollow portion of each main support may reduce the amount of material used in the construction of the quick coupler 28, thereby significantly reducing the cost of the quick coupler (e.g., as compared to a quick coupler having solid main supports). The thickness of each side member 88 and the thickness of the connecting member 90 of each main support may be particularly selected to enable the quick coupler to transfer the load of the implement to the three-point hitch (e.g., a maximum expected load) while maintaining the structural integrity of the quick coupler. While the connecting member 90 is positioned on the implement side of the quick coupler 28 in the illustrated embodiment, in other embodiments, the connecting member may be positioned on the work vehicle side of the quick coupler or at any other suitable location along the longitudinal axis. In addition, while each main support includes a single connecting member in the illustrated embodiment, in other embodiments, at least one main support may include multiple connecting members (e.g., 2, 3, 4, etc.). For example, in certain embodiments, a second connecting member (e.g., plate) may be coupled to at least one main support on the work vehicle side of the quick coupler to enclose the hollow portion. Furthermore, while each main support includes a hollow portion in the illustrated embodiment, in other embodiments, at least one main support may not include a hollow portion. In certain embodiments, at least one cross-member may extend between the lateral side members of at least one main support (e.g., to enhance the structural rigidly and/or the strength of the main support). In such embodiments, the connecting member(s) may be omitted.

In the illustrated embodiment, the cross-beam 54 includes a top member 92 extending along the lateral axis 48 and a bottom member 94 extending along the lateral axis 48. The top member 92 and the bottom member 94 are spaced apart to form a hollow portion 96 (e.g., cavity) between the top member 92 and the bottom member 94. In addition, the cross-beam 54 includes a connecting member 97 extending between the top member 92 and the bottom member 94. In the illustrated embodiment, the connecting member 97 is positioned on the implement side of the quick coupler 28. Accordingly, the hollow portion 96 is positioned on the work vehicle side of the quick coupler, opposite the implement side of the quick coupler. However, in other embodiments, the connecting member may be positioned on the work vehicle side of the quick coupler, such that the hollow portion is positioned on the implement side of the quick coupler, or the connecting member may be positioned at another suitable location along the longitudinal axis. Furthermore, while the cross-beam includes a single connecting member in the illustrated embodiment, in other embodiments, the cross-beam may include more or fewer connecting members (e.g., 0, 1, 2, 3, 4, etc.). For example, the cross-beam may include two connecting members, and the hollow portion may be positioned between the connecting members along the longitudinal axis. In addition, in certain embodiments, the connecting member may be omitted, and the top member may be coupled to the bottom member by one or more cross-members, such as the angled cross-members disclosed below.

In addition, the cross-beam 54 includes a first angled cross-member 98 extending from the bottom member 94 to the top member 92 within the hollow portion 96. The cross-beam 54 also includes a second angled cross-member 100 extending from the bottom member 94 to the top member 92 within the hollow portion 96. As illustrated, the first angled cross-member 98 intersects the second angled cross-member 100 at a point/apex 102 along the top member 94. Accordingly, the cross-beam 54 has a triangular support 104 disposed within the hollow portion 96, in which a base 106 of the triangular support 104 is formed by the bottom member 94, and the apex 102 of the triangular support 104 is formed at the top member 92. In the illustrated embodiment, the first and second angled cross-members/triangular support is positioned on the first lateral side 46 of the quick coupler 28 between the first main support 44 and the cross-beam/quick coupler center 84. However, in other embodiments, the first and second angled cross-members/triangular support may be positioned at any other suitable location along the length of the cross-beam. As used herein with regard to the cross-beam, “cross-member” refers to a member extending from the bottom member to the top member within the hollow portion, as compared to an end member, which forms an end of the cross-beam/lateral end of the hollow portion, or a connecting member, which forms a longitudinal end of the hollow portion.

Furthermore, in the illustrated embodiment, the cross-beam 54 includes a third angled cross-member 108 extending from the bottom member 94 to the top member 92 within the hollow portion 96. The cross-beam 54 also includes a fourth angled cross-member 110 extending from the bottom member 94 to the top member 92 within the hollow portion 96. As illustrated, the third angled cross-member 108 intersects the fourth angled cross-member 110 at a point/apex 112 along the top member 94. Accordingly, the cross-beam 54 has a second triangular support 114 disposed within the hollow portion 96, in which a base 116 of the second triangular support 114 is formed by the bottom member 94, and the apex 112 of the second triangular support 114 is formed at the top member 92. In the illustrated embodiment, the third and fourth angled cross-members/second triangular support is positioned on the second lateral side 52 of the quick coupler 28 between the second main support 50 and the cross-beam/quick coupler center 84. However, in other embodiments, the third and fourth angled cross-members/second triangular support may be positioned at any other suitable location along the length of the cross-beam.

The hollow portion 96 of the cross-beam 54 substantially reduces the amount of material used in the construction of the quick coupler 28 (e.g., as compared to a quick coupler having a solid cross-beam), and the angled cross-members/triangular supports provide sufficient support to enable the quick coupler 28 to transfer the load of the implement to the three-point hitch. For example, the angled cross-members/triangular supports may be shaped/configured to effectively transfer a load applied to the cross-beam 54 by the upper link in a downward direction along the vertical axis 60 to the main supports (e.g., while resisting bending of the cross-beam). Due to the reduced material used in the construction of the quick coupler, the cost of the quick coupler may be significantly reduced (e.g., as compared to a quick coupler having a solid cross-beam). While the cross-beam has two sets of angled cross-members/triangular supports in the illustrated embodiment, in other embodiments, the cross-beam may have more or fewer sets of angled cross-members/triangular supports (e.g., 1, 2, 3, 4, 5, 6, or more). Furthermore, while the first and second triangular supports are positioned on opposite lateral sides of the cross-beam center in the illustrated embodiment, in other embodiments, each triangular support may be positioned at any other suitable location along the length/lateral extent of the cross-beam. For example, in certain embodiments, two triangular supports may be position on one side of the cross-beam center, and no triangular supports may be positioned on the opposite side of the cross-beam center. Furthermore, in certain embodiments, a triangular support may extend laterally across the cross-beam center.

In the illustrated embodiment, each pair of angled cross-members form a triangular support, in which the base of the triangular support is formed by the bottom member, and the apex of the triangular support is formed at the top member. However, in other embodiments, at least one pair of angled cross-members may form a triangular support, in which the base of the triangular support is formed by the top member, and the apex of the triangular support is formed at the bottom member. In such embodiments, the pair of angled cross-members may form a triangular support that is inverted relative to the triangular supports disclosed above. In addition, one angled cross-member may form a portion of two adjust triangular supports (e.g., one triangular support having an apex formed at the top member and one triangular support having an apex formed at the bottom member). Furthermore, in certain embodiments, the cross-beam may include one or more cross-members, which extend from the bottom member to the top member within the hollow portion, that do not form a portion of a triangular support. Such cross-member(s) may be angled or perpendicular to the top member and/or the bottom member. For example, in certain embodiments, the cross-beam may include any suitable number of cross-members that do not form a portion of a triangular support (e.g., 0, 1, 2, 3, 4, 5, 6, 7, 8, or more) and any suitable number of cross-members that form a portion of a triangular support (e.g., 0, 2, 3, 4, 5, 6, 7, 8, or more).

While the quick coupler 28 is described above with reference to a first main support 44, a second main support 50, and a cross-beam 54, the quick coupler may also be described with reference to an outer shell, an inner shell, and cross-members extending from the outer shell to the inner shell. In the illustrated embodiment, the quick coupler 28 has an outer shell 118 including the outer lateral side member 88 of the first main support 44, the outer lateral side member 88 of the second main support 50, and the top member 92 of the cross-beam 54. In addition, the quick coupler 28 has an inner shell 120 including the inner lateral side member 88 of the first main support 44, the inner lateral side member 88 of the second main support 50, and the bottom member 94 of the cross-beam 54. The inner shell 120 is spaced apart from the outer shell 118 to form a hollow portion 122 between the outer shell 118 and the inner shell 120. The hollow portion 122 includes the hollow portion 86 of the first main support 44, the hollow portion 86 of the second main support 50, and the hollow portion 96 of the cross-beam 54.

The quick coupler 28 also includes one or more primary cross-members extending from the outer shell 118 to the inner shell 120 within the hollow portion 122. Each primary cross-member extends away from the lateral center 84 of the quick coupler 28 along a respective primary path from the outer shell 118 to the inner shell 120. In the illustrated embodiment, the second angled cross-member 100 and the third angled cross-member 108 are primary cross-members. As illustrated, the second angled cross-member 100 and the third angled cross-member 108 extend from the outer shell 118 to the inner shell 120 within the hollow portion 122. In addition, the second angled cross-member 100 extends away from the lateral center 84 along a respective primary path 124 from the outer shell 118 to the inner shell 120, and the third angled cross-member 108 extends away from the lateral center 84 along a respective primary path 126 from the outer shell 118 to the inner shell 120. While the quick coupler includes two primary cross-members in the illustrated embodiment, in other embodiments, the quick coupler may include more or fewer primary cross-members (e.g., 0, 1, 3, 4, 5, 6, or more). In addition, while the primary cross-members are positioned on opposite sides of the lateral center in the illustrated embodiment, in other embodiments, each primary cross-member may be positioned at any suitable location along the hollow portion of the quick coupler.

Furthermore, the quick coupler 28 includes one or more secondary cross-members extending from the outer shell 118 to the inner shell 120 within the hollow portion 122. Each secondary cross-member extends toward the lateral center 84 of the quick coupler 28 along a respective secondary path from the outer shell 118 to the inner shell 120. In the illustrated embodiment, the first angled cross-member 98 and the fourth angled cross-member 110 are secondary cross-members. As illustrated, the first angled cross-member 98 and the fourth angled cross-member 110 extend from the outer shell 118 to the inner shell 120 within the hollow portion 122. In addition, the first angled cross-member 98 extends toward the lateral center 84 along a respective secondary path 128 from the outer shell 118 to the inner shell 120, and the fourth angled cross-member 110 extends toward the lateral center 84 along a respective secondary path 130 from the outer shell 118 to the inner shell 120. In the illustrated embodiment, the quick coupler 28 also includes a third secondary cross-member 132 at the first main support 44 and a fourth secondary cross-member 134 at the second main support 50. Accordingly, in the illustrated embodiment, two secondary cross-members are positioned on each lateral side of the lateral center. However, in other embodiments, each secondary cross-member may be positioned at any suitable location along the hollow portion of the quick coupler. In addition, while the quick coupler includes four secondary cross-members in the illustrated embodiment, in other embodiments, the quick coupler may include more or fewer secondary cross-members (e.g., 0, 1, 2, 3, 5, 6, or more).

In the illustrated embodiment, each primary cross-member intersects a respective secondary cross-member at a point along the outer shell. As illustrated, the second angled cross-member 100 intersects the first angled cross-member 98 at a point (e.g., apex 102) along the outer shell 118, and the third angled cross-member 108 intersects the fourth angled cross-member 110 at a point (e.g., apex 112) along the outer shell 118. Furthermore, in the illustrated embodiment, the outer shell and the inner shell extend continuously between the ends (e.g., vertical ends) of the quick coupler/hollow portion. However, in other embodiments, the inner shell and/or the outer shell may include at least one gap within a portion of the respective shell. As used herein with regard to the primary and secondary cross-members, “cross-member” refers to a member extending from the outer shell to the inner shell within the hollow portion, as compared to an end member, which forms an end (e.g., vertical end) of the quick coupler/hollow portion, or a connecting member, which forms a longitudinal end of the hollow portion.

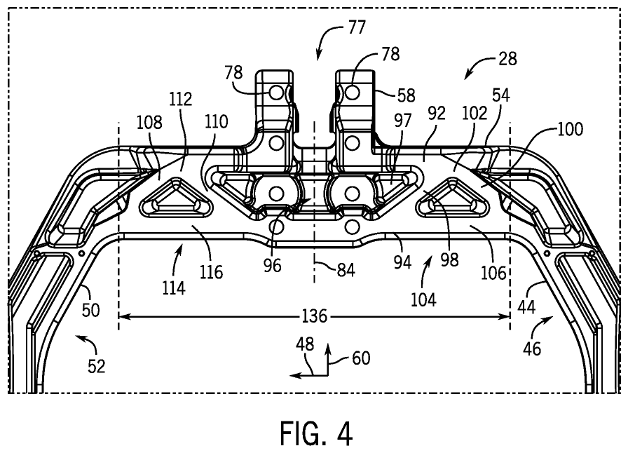

FIG. 4 is a rear view of a cross-beam 54 of the quick coupler 28 of FIG. 2. As illustrated, the top member 92 extends along a length 136 of the cross-beam 54, and the bottom member 94 extends along the length 136 of the cross-beam 54. In addition, the mounting feature 77 is positioned at the center 84 of the cross-beam 54 along the length 136. In the illustrated embodiment, the first and second triangular supports are positioned symmetrically about the center 84 of the cross-beam. For example, the cross-beam 54 may be symmetrical about the cross-beam center 84. However, in other embodiments, the cross-beam may be asymmetrical about the cross-beam center. For example, the first and second angled cross-members/first triangular support may be positioned closer to the center along the lateral axis than the third and fourth angled cross-members/second triangular support. Alternatively, the third and fourth angled cross-members/second triangular support may be positioned closer to the center along the lateral axis than the first and second angled cross-members/first triangular support.

The thickness of the top member 92, the thickness of the bottom member 94, and the thickness of the connecting member 97 of the cross-beam 54 may be particularly selected to enable the quick coupler to transfer the load of the implement to the three-point hitch (e.g., a maximum expected load) while maintaining the structural integrity of the quick coupler. In addition the thickness of the first angled cross-member 98, the thickness of the second angled cross-member 100, the thickness of the third angled cross-member 108, and the thickness of the fourth angled cross-member 110 may be particularly selected to enable the quick coupler to transfer the load of the implement to the three-point hitch (e.g., a maximum expected load) while maintaining the structural integrity of the quick coupler. Furthermore, the angle of the first angled cross-member 98, the angle of the second angled cross-member 100, the angle of the third angled cross-member 108, and the angle of the fourth angled cross-member 110 (e.g., relative to the top member 92, relative to the bottom member 94, relative to the lateral axis 48, relative to the vertical axis 60, etc.) may be particularly selected to enable the quick coupler to transfer the load of the implement to the three-point hitch (e.g., a maximum expected load) while maintaining the structure integrity of the quick coupler.

In addition, the length of the base 106 of the first triangular support 104 and the length of the base 116 of the second triangular support 114 may be particularly selected to enable the triangular supports to effectively transfer a load applied to the cross-beam 54 by the upper link in a downward direction along the vertical axis 60 to the main supports (e.g., while resisting bending of the cross-beam). For example, the length of the base of at least one triangular support may be 10 percent to 70 percent, 10 percent to 60 percent, 15 percent to 50 percent, 20 percent or 45 percent, 25 percent to 45 percent, or 30 percent to 40 percent of the length 136 of the cross-beam 54. Furthermore, while each cross-member (e.g., angled cross-member) is substantially straight in the illustrated embodiment, in other embodiments, at least one cross-member may have another suitable shape, such as curved or polygonal. For example, in certain embodiments, at least one cross-member may extend along a tortuous path between the top member and the bottom member.

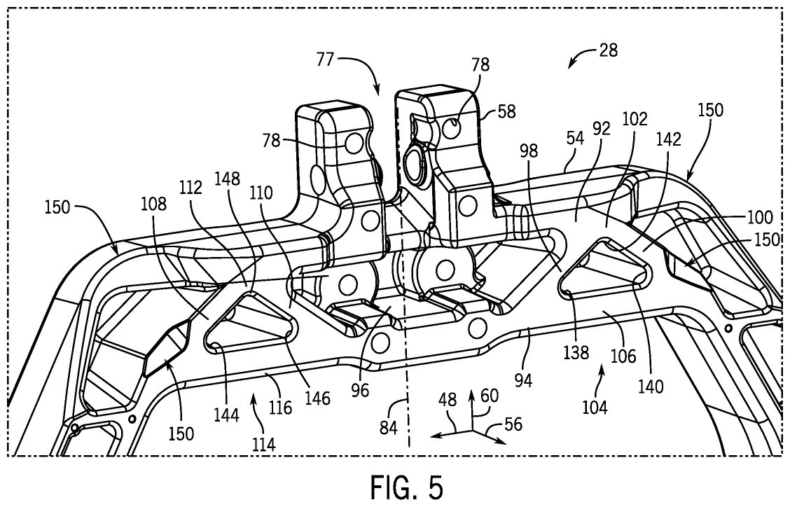

FIG. 5 is a rear perspective view of the cross-beam 54 of the quick coupler 28 of FIG. 2. In the illustrated embodiment, a first interface 138 between the first angled cross-member 98 and the bottom member 94 is filleted, and a second interface 140 between the second angled cross-member 100 and the bottom member 94 is filleted. In addition, a third interface 142 between the first angled cross-member 98 and the second angled cross-member 100 is filleted. Each fillet substantially reduces the possibility of forming a stress concentration at the respective interface, thereby enhancing the longevity of the quick coupler.

Furthermore, in the illustrated embodiment, a fourth interface 144 between the third angled cross-member 108 and the bottom member 94 is filleted, and a fifth interface 146 between the fourth angled cross-member 110 and the bottom member 94 is filleted. In addition, a sixth interface 148 between the third angled cross-member 108 and the fourth angled cross-member 110 is filleted. Each fillet substantially reduces the possibility of forming a stress concentration at the respective interface, thereby enhancing the longevity of the quick coupler. While each interface disclosed above is filleted in the illustrated embodiment, in other embodiments, at least one interface may have another suitable shape (e.g., chamfered, etc.). Furthermore, other interfaces between elements within the quick coupler may be filleted or may have another suitable shape (e.g., chamfered, etc.).

In the illustrated embodiment, the quick coupler 28 includes recesses 150 configured to provide clearance between the quick coupler 28 and rear wheels/tracks of the work vehicle. As illustrated, each recess 150 is formed at the interface between the cross-beam 54 and the respective main support. However, in other embodiments, at least one recess may be formed in another suitable location on the quick coupler to provide clearance between the quick coupler and the rear wheel(s)/track(s) (e.g., alone or in combination with the illustrated recesses). The recesses 150 enable the quick coupler 28 to be positioned closer to the rear wheels/tracks (e.g., as compared to a quick coupler without the recesses), thereby increasing the load carrying capacity of the three-point hitch.

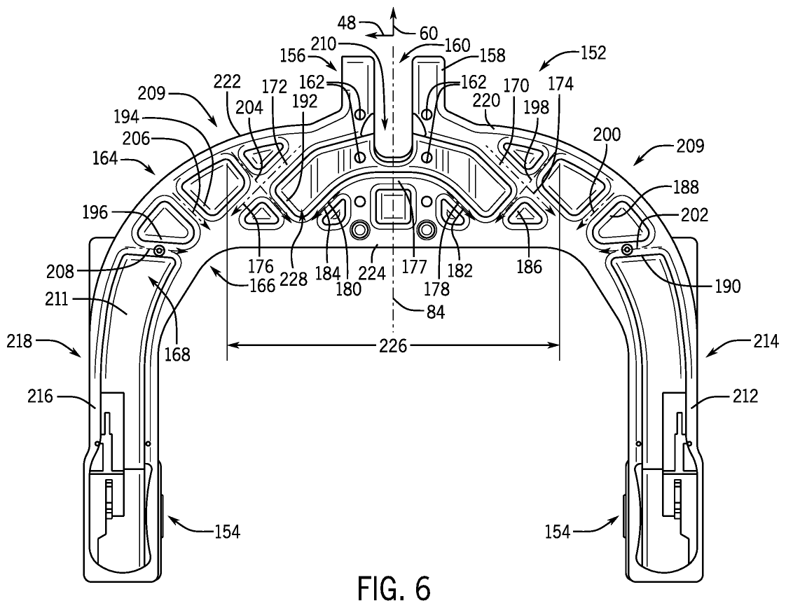

FIG. 6 is a rear view of another embodiment of a quick coupler 152 configured to couple to the three-point hitch of FIG. 1. In the illustrated embodiment, the quick coupler 152 includes two lower openings 154 configured to receive the lower hitch pins, and the quick coupler 152 includes an upper opening 156 configured to receive the upper hitch pin. The upper opening 156 is formed within a support 158 of the quick coupler 152. As previously discussed, the hitch pins are configured to be disposed through the openings in the three-point hitch and the quick coupler to couple the quick coupler 152 to the three-point hitch.

Furthermore, the quick coupler 152 includes two lower hooks. Each lower hook is configured to engage a corresponding hitch pin of the implement. In addition, the quick coupler 152 includes a mounting feature 160 having apertures 162 configured to receive fasteners for coupling an upper/anti-rotation hook to a corresponding portion of the quick coupler 152. For example, a mount may be coupled to (e.g., integrally formed with) the upper/anti-rotation hook, and the mount may include apertures configured to receive the fasteners. The fasteners may be disposed through the apertures of the mount and the apertures 162 of the mounting feature 160 to couple the upper/anti-rotation hook to the corresponding portion of the quick coupler 152. All of the features and variations with regard to the openings, the hooks, and the mounting feature disclosed above with regard to the embodiment of FIGS. 2-5 may be included within the illustrated quick coupler.

In the illustrated embodiment, the quick coupler 152 includes an outer shell 164 and an inner shell 166. The inner shell 166 is spaced apart from the outer shell 164 to form a hollow portion 168 between the outer shell 164 and the inner shell 166. The quick coupler 152 also includes one or more primary cross-members extending from the outer shell 164 to the inner shell 166 within the hollow portion 168. Each primary cross-member extends away from the lateral center 84 of the quick coupler 152 along a respective primary path from the outer shell 164 to the inner shell 166. In the illustrated embodiment, the quick coupler 152 includes a first primary cross-member 170 and a second primary cross-member 172. Each primary cross-member extends from the outer shell 164 to the inner shell 166 within the hollow portion 168. In addition, the first primary cross-member 170 extends away from the lateral center 84 along a respective primary path 174 from the outer shell 164 to the inner shell 166, and the second primary cross-member 172 extends away from the lateral center 84 along a respective primary path 176 from the outer shell 164 to the inner shell 166.

As illustrated, the primary cross-members are spaced apart from one another along the lateral axis 48 of the quick coupler 152. Furthermore, in the illustrated embodiment, the first and second primary cross-members are positioned on opposite lateral sides of the lateral center 84. However, in other embodiments, each primary cross-member may be positioned at any suitable location along the hollow portion of the quick coupler. In addition, while the quick coupler includes two primary cross-members in the illustrated embodiment, in other embodiments, the quick coupler may include more or fewer primary cross-members (e.g., 0, 1, 3, 4, 5, 6, or more).

In the illustrated embodiment, the quick coupler 152 includes one or more reinforcing ribs extending from a central support 177 to the inner shell 166 within the hollow portion 168. Each reinforcing rib extends away from the lateral center 84 of the quick coupler 152 along a respective path from the central support 177 to the inner shell 166. In the illustrated embodiment, the quick coupler 152 includes a first reinforcing rib 178 and a second reinforcing rib 180. Each reinforcing rib extends from the central support 177 to the inner shell 166 within the hollow portion 168. In addition, the first reinforcing rib 178 extends away from the lateral center 84 along a respective path 182 from the central support 177 to the inner shell 166, and the second reinforcing rib 180 extends away from the lateral center 84 along a respective path 184 from the central support 177 to the inner shell 166.

As illustrated, the reinforcing ribs are spaced apart from one another along the lateral axis 48 of the quick coupler 152. Furthermore, in the illustrated embodiment, the first and second reinforcing ribs are positioned on opposite lateral sides of the lateral center 84. However, in other embodiments, each reinforcing rib may be positioned at any suitable location along the hollow portion of the quick coupler. In addition, while the quick coupler includes two reinforcing ribs in the illustrated embodiment, in other embodiments, the quick coupler may include more or fewer reinforcing ribs (e.g., 0, 1, 3, 4, 5, 6, or more). Furthermore, while each reinforcing rib extends from the central support to the inner shell in the illustrated embodiment, in other embodiments, at least one reinforcing rib may extend between any two suitable elements of the quick coupler. In addition, at least one reinforcing rib may extend toward the lateral center along a respective path.

Furthermore, the quick coupler 152 includes one or more secondary cross-members extending from the outer shell 164 to the inner shell 166 within the hollow portion 168. Each secondary cross-member extends toward the lateral center 84 of the quick coupler 152 along a respective secondary path from the outer shell 164 to the inner shell 166. In the illustrated embodiment, the quick coupler 152 includes a first secondary cross-member 186, a second secondary cross-member 188, a third secondary cross-member 190, a fourth secondary cross-member 192, a fifth secondary cross-member 194, and a sixth secondary cross-member 196. Each secondary cross-member extends from the outer shell 164 to the inner shell 166 within the hollow portion 168. In addition, the first secondary cross-member 186 extends toward the lateral center 84 along a respective secondary path 198 from the outer shell 164 to the inner shell 166, the second secondary cross-member 188 extends toward the lateral center 84 along a respective secondary path 200 from the outer shell 164 to the inner shell 166, the third secondary cross-member 190 extends toward the lateral center 84 along a respective secondary path 202 from the outer shell 164 to the inner shell 166, the fourth secondary cross-member 192 extends toward the lateral center 84 along a respective secondary path 204 from the outer shell 164 to the inner shell 166, the fifth secondary cross-member 194 extends toward the lateral center 84 along a respective secondary path 206 from the outer shell 164 to the inner shell 166, and the sixth secondary cross-member 196 extends toward the lateral center 84 along a respective secondary path 208 from the outer shell 164 to the inner shell 166.

As illustrated, certain secondary cross-members are spaced apart from one another along the lateral axis 48 of the quick coupler 152. Furthermore, in the illustrated embodiment, the first, second, and third secondary cross-members are positioned on one lateral side of the lateral center 84, and the fourth, fifth, and sixth secondary cross-members are positioned on the opposite lateral side of the lateral center 84. However, in other embodiments, each secondary cross-member may be positioned at any suitable location along the hollow portion of the quick coupler. In addition, while the quick coupler includes six secondary cross-members in the illustrated embodiment, in other embodiments, the quick coupler may include more or fewer secondary cross-members (e.g., 0, 1, 2, 3, 4, 5, 7, 8, or more).

In certain embodiments, the primary cross-members and the reinforcing ribs are configured to reduce compression of the quick coupler (e.g., a reduction in the distance between the outer shell and the inner shell), and the secondary cross-members are configured to reduce expansion of the quick coupler (e.g., an increase in the distance between the outer shell and the inner shell). Accordingly, the primary cross-members and the reinforcing ribs are configured to support the quick coupler in compression, and the secondary cross-members are configured to support the quick coupler in tension. Furthermore, in the illustrated embodiment, the first primary cross-member 170 intersects the first secondary cross-member 186 within the hollow portion 168, and the second primary cross-member 172 intersects the fourth secondary cross-member 192 within the hollow portion 168. As used herein with regard to the primary and secondary cross-members, “cross-member” refers to a member extending from the outer shell to the inner shell within the hollow portion, as compared to an end member, which forms an end (e.g., vertical end) of the quick coupler/hollow portion, or a connecting member, which forms a longitudinal end of the hollow portion.

In the illustrated embodiment, the outer shell 164 has curved portions 209 that extend across the intersections with the cross-members. The curved portions 209 are configured to reduce compression of the quick coupler (e.g., a reduction in the distance between the outer shell and the inner shell). While each curved portion extends across the intersections with the cross-members in the illustrated embodiment, in other embodiments, at least one curved portion may extend across a different portion of the outer shell. Furthermore, while the outer shell 164 has two curved portions 209 in the illustrated embodiment, in other embodiments, at least one of the curved portions may be omitted (e.g., the outer shell may have at least one substantially straight portion that extends across the intersections with the cross-members). In addition, in the illustrated embodiment, the outer shell 164 has a recess 210 at the mounting feature 160. However, in other embodiments, the recess may be omitted (e.g., the outer shell may extend in a substantially straight path across the mounting feature). Furthermore, in the illustrated embodiment, the outer shell and the inner shell extend continuously between the ends (e.g., vertical ends) of the quick coupler/hollow portion. However, in other embodiments, the inner shell and/or the outer shell may include at least one gap within a portion of the respective shell.

In the illustrated embodiment, the quick coupler 152 includes a connecting member 211 extending between the outer shell 164 and the inner shell 166. In the illustrated embodiment, the connecting member 211 is positioned on the implement side of the quick coupler 152. Accordingly, the hollow portion 168 is positioned on the work vehicle side of the quick coupler, opposite the implement side of the quick coupler. However, in other embodiments, the connecting member may be positioned on the work vehicle side of the quick coupler, such that the hollow portion is positioned on the implement side of the quick coupler, or the connecting member may be positioned at another suitable location along the longitudinal axis. Furthermore, while the quick coupler includes a single connecting member in the illustrated embodiment, in other embodiments, the quick coupler may include more or fewer connecting members (e.g., 0, 1, 2, 3, 4, etc.). For example, the quick coupler may include two connecting members, and the hollow portion may be positioned between the connecting members along the longitudinal axis. In addition, in certain embodiments, the connecting member may be omitted, and the outer shell may be coupled to the inner shell by the cross-members. Because the cross-members establish the hollow portion between the inner and outer shells, the amount of material used in the construction of the quick coupler may be reduced, as compared to a quick coupler without the hollow portion.

While the quick coupler 152 is described above with reference to an outer shell 164, an inner shell 166, and cross-members extending from the outer shell to the inner shell, the quick coupler may also be described with reference to a first main support, a second main support, and a cross-beam extending between the first main support and the second main support. In the illustrated embodiment, the quick coupler 152 includes a first main support 212 positioned on a first lateral side 214 of the quick coupler 152 (e.g., a first side along the lateral axis 48). In addition, the quick coupler 152 includes a second main support 216 positioned on a second lateral side 218 of the quick coupler 152 (e.g., a second side along the lateral axis 48), in which the second lateral side 218 is opposite the first lateral side 214. Furthermore, the quick coupler 152 includes a cross-beam 220 extending between the first main support 212 and the second main support 216 along the lateral axis 48. In addition, each lower opening 154 is formed within a respective main support, and the upper opening 156 is formed within the support 158 extending from the cross-beam 220. As illustrated, the upper opening 156 is positioned above the lower openings 154 along the vertical axis 60.

In the illustrated embodiment, the cross-beam 220 includes a top member 222 (e.g., portion of the outer shell 164) extending along the lateral axis 48 and a bottom member 224 (e.g., portion of the inner shell 166) extending along the lateral axis 48. As illustrated, the top member 222 extends along a length 226 of the cross-beam 220, and the bottom member 224 extends along the length 226 of the cross-beam 220. The top member 222 and the bottom member 224 are spaced apart to form a hollow portion 228 (e.g., cavity) between the top member 222 and the bottom member 224. In the illustrated embodiment, the hollow portion 168 of the quick coupler 152 includes the hollow portion 228 of the cross-beam 220.

Furthermore, the cross-beam 220 includes one or more cross-members extending from the bottom member 224 to the top member 222. In the illustrated embodiment, the cross-beam 220 includes a first angled cross-member (e.g., corresponding to the first primary cross-member 170), a second angled cross-member (e.g., corresponding to the second primary cross-member 172), a third angled cross-member (e.g., corresponding to the first secondary cross-member 186), and a fourth angled cross-member (e.g., corresponding to the fourth secondary cross-member 192). Furthermore, in the illustrated embodiment, various interfaces between intersecting cross-members are filleted, and various interfaces between cross-members and the top member 222/outer shell 164 and/or the bottom member 224/inner shell 166 are filleted. As previously discussed, each fillet substantially reduces the possibility of forming a stress concentration at the respective interface, thereby enhancing the longevity of the quick coupler. While filleted interfaces are disclosed above, in certain embodiments, at least one interface may have another suitable shape (e.g., chamfered, etc.).

In certain embodiments, the quick coupler 152 (e.g., excluding the upper/anti-rotation hook) may be formed via a casting process. For example, molten metal (e.g., steel, iron, etc.) may be poured into a mold cavity having the shape of the quick coupler. After the metal cools and hardens, the quick coupler may be removed from the mold cavity and the opening/apertures may be formed (e.g., drilled, etc.) in the quick coupler. Accordingly, the quick coupler (e.g., excluding the upper/anti-rotation hook) may be formed as a single cast element (e.g., including the outer shell, the inner shell, the primary cross-members, and the secondary cross-members), thereby reducing the manufacturing cost of the quick coupler (e.g., as compared to a quick coupler formed entirely by a machining process). In certain embodiments, the quick coupler 152 may be formed from ductile iron via the casting process disclosed above. For example, the quick coupler may be formed from grade C or grade D ductile iron. Furthermore, in certain embodiments, the quick coupler (e.g., excluding the upper/anti-rotation hook) may be formed from a single piece of material via an additive manufacturing process and/or a reductive manufacturing process (e.g., alone or in combination with the molding process).

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A quick coupler for a three-point hitch, comprising:
a cross-beam configured to extend between a first main support and a second main support, wherein the cross-beam is configured to support an anti-rotation hook;
wherein the cross-beam comprises:
a top member extending along a length of the cross-beam;
a bottom member extending along the length of the cross-beam, wherein the top member and the bottom member are spaced apart to form a hollow portion between the top member and the bottom member; and
at least one angled cross-member extending from the bottom member to the top member within the hollow portion, wherein the at least one angled cross-member is angled relative to a vertical axis.

2. The quick coupler of claim 1, wherein the cross-beam is a single cast element.

3. The quick coupler of claim 1, wherein the at least one angled cross-member comprises:
a first angled cross-member extending from the bottom member to the top member within the hollow portion; and
a second angled cross-member extending from the bottom member to the top member within the hollow portion.

4. The quick coupler of claim 3, wherein the first angled cross-member intersects the second angled cross-member at a point along the top member.

5. The quick coupler of claim 4, wherein a first interface between the first angled cross-member and the bottom member is filleted, a second interface between the second angled cross-member and the bottom member is filleted, a third interface between the first angled cross-member and the second angled cross-member is filleted, or a combination thereof.

6. The quick coupler of claim 3, wherein the first and second angled cross-members are positioned on a first side of a lateral center of the cross-beam.

7. The quick coupler of claim 6, wherein the cross-beam comprises:
a third angled cross-member extending from the bottom member to the top member within the hollow portion; and
a fourth angled cross-member extending from the bottom member to the top member within the hollow portion;
wherein the third and fourth angled cross-members are positioned on a second side of the lateral center of the cross-beam, opposite the first side.

8. A quick coupler for a three-point hitch, comprising:
a cross-beam configured to extend between a first main support and a second main support, wherein the cross-beam is configured to support an anti-rotation hook, the cross-beam has a cavity formed between a top member and a bottom member of the cross-beam, the cross-beam comprises a triangular support disposed within the cavity, a base of the triangular support is formed by one of the bottom member of the cross-beam or the top member of the cross-beam, and an apex of the triangular support is formed at the other of the bottom member of the cross-beam or the top member of the cross-beam.

9. The quick coupler of claim 8, wherein the cross-beam is a single cast element.

10. The quick coupler of claim 8, wherein the cross-beam comprises a mounting feature configured to secure the anti-rotation hook to the quick coupler.

11. The quick coupler of claim 8, wherein the triangular support is positioned on a first side of a lateral center of the cross-beam.

12. The quick coupler of claim 11, wherein the cross-beam comprises a second triangular support disposed within the cavity, a base of the second triangular support is formed by one of the bottom member of the cross-beam or the top member of the cross-beam, and an apex of the second triangular support is formed at the other of the bottom member of the cross-beam or the top member of the cross-beam.

13. The quick coupler of claim 12, wherein the second triangular support is positioned on a second side of the lateral center of the cross-beam, opposite the first side.

14. A quick coupler for a three-point hitch, comprising:
an outer shell;
an inner shell spaced apart from the outer shell to form a hollow portion between the outer shell and the inner shell;
at least one primary cross-member extending from the outer shell to the inner shell within the hollow portion, wherein the at least one primary cross-member extends away from a lateral center of the quick coupler along a respective primary path from the outer shell to the inner shell; and
at least one secondary cross-member extending from the outer shell to the inner shell within the hollow portion, wherein the at least one secondary cross-member extends toward the lateral center of the quick coupler along a respective secondary path from the outer shell to the inner shell.

15. The quick coupler of claim 14, wherein the outer shell, the inner shell, the at least one primary cross-member, and the at least one secondary cross-member are formed as a single cast element.

16. The quick coupler of claim 14, wherein the at least one primary cross-member comprises a plurality of primary cross-members spaced apart from one another along a lateral axis of the quick coupler.

17. The quick coupler of claim 14, wherein the at least one secondary cross-member comprises a plurality of secondary cross-members spaced apart from one another along a lateral axis of the quick coupler.

18. The quick coupler of claim 17, wherein at least two secondary cross-members of the plurality of secondary cross-members are positioned on one lateral side of the lateral center.

19. The quick coupler of claim 14, wherein the at least one primary cross-member intersects the at least one secondary cross-member within the hollow portion.

20. The quick coupler of claim 14, wherein the at least one primary cross-member intersects the at least one secondary cross-member at a point along the outer shell.
